(19) United States
(12) Patent Application Publication
(10) Pub. No.: US 2018/0217029 A1
(43) Pub. Date: Aug. 2, 2018

(54) Aquatic Sampler and Collection Apparatus

(71) Applicant: Woods Hole Oceangraphic Institution, Woods Hole, MA (US)

(72) Inventors: Andrew S. Billings, N. Falmouth, MA (US); Cari L. KAISER, Woods Hole, MA (US); Cindy Lee VAN DOVER, Beaufort, NC (US)

(21) Appl. No.: 15/747,747

(22) PCT Filed: Jul. 26, 2016
(86) PCT No.: PCT/US16/44061

§ 371 Date: Jan. 25, 2018

Related U.S. Application Data
(60) Provisional application No. 62/197,117, filed on Jul. 27, 2015.

(51) Int. Cl. G01N 1/14

(52) U.S. Cl. CPC G01N 1/14; G01N 2001/1025

(57) ABSTRACT

An aquatic particle sampling and collection apparatus comprising a tube within a tube cylindrical collection system wherein an inner tube is housed within an outer tube wherein the outer tube has a front end that is flared in a frustum shape to collect water. The inner tube defines an open chamber lined with a net or other collection apparatus which concludes with a conical cod end. An axial flow pump is situated within the collection system to facilitate the movement of water through the system thereby drawing particles in to be collected. The apparatus is paired with a subsea vehicle that allows for controlled collection and sampling. In various embodiments, the apparatus can be used to collect both bio particles such as plankton and non-bio particles such as plastics from the ocean. Where sampling is desired, the apparatus may include a disk after the conical cod end upon which the samples are collected.

### CROSS REFERENCE TO RELATED APPLICATIONS AND PUBLICATIONS

This application claims priority to a provisional application, entitled High Volume Autonomous Deep Ocean Plankton Sampler, U.S. Application No. 62/197,117, which was filed on Jul. 27, 2015. This application also references the publication Billings et al. (2016) “SyPRID sampler: A large-volume, high-resolution, autonomous, deep-ocean precision plankton sampling system” Deep-Sea Research II (doi:10.1016/j.dsr2.2016.05.007), the PCT Patent Application entitled Improved-Efficiency Submersible Thruster, Application No. PCT/US2015/037548, and the PCT Patent Application entitled Asymmetric Propulsion and Maneuvering System, Application No. PCT/US2015/023970 which are incorporated herein by reference in entirety.

### STATEMENT OF RIGHTS TO INVENTIONS MADE UNDER FEDERALLY SPONSORED RESEARCH

This invention was made with Government support under Grant Nos. OCE-1031050, OCE-1030453, and OCE-1036843 awarded by the National Science Foundation. The U.S. Government has certain rights in this invention.

### TECHNICAL FIELD

The system and methods described herein relate to the field of collecting and sampling particles (bio and non-bio particles) in an aquatic environment (e.g., salt water, fresh water, deep water). The system and methods described herein also relate to the field of plankton sampling, particularly delicate marine organisms, using an underwater vehicle, such as an autonomous underwater vehicle (AUV), at a plurality of depths in an aquatic environment, and the collection of plastics such as microplastics from aquatic environments.

### BACKGROUND OF INVENTION

Both academia and industry have great interest and use for the controllable collection of particles in aquatic or marine environments such as plankton and plastics. For example, the collection and analysis of plastic particles in marine environments can be helpful in efforts to clean the oceans and rid them of plastic contaminants, as well as to determine the source of the contaminants to help prevent future contamination. Likewise, the controllable collection of bio and non-bio particles will have great impact in research that may have global implications.

The study of plankton is a prime illustrative example as it has proven an area that could benefit from the controllable collection of particles (in this case, plankton particles). Phytoplankton are the foundation of the ocean food chain, feeding and providing energy to every form of marine life from microscopic, animal-like zooplankton to the world's largest whales. Plankton photosynthesis accounts for roughly half the primary productivity on Earth and is integral to the ocean's carbon cycle. Phytoplankton are responsible for the transfer of carbon dioxide from the atmosphere to the ocean with these tiny cells absorbing more than 100 million tons of inorganic carbon around the world every day. Therefore, studying patterns in plankton distribution is vital to discover more about the impact of climate change on marine ecosystems. Warming of the world's oceans has already caused major shifts in plankton distribution and abundance on a global scale. Continuing decreases in plankton size and productivity would have a catastrophic effect on the supply of available energy within the ocean food chain.

Thus, controlled collection and sampling can help to understand and solve salient issues in research. For example, it can help to understand salient issues in zooplankton research that include understanding the formation, persistence and significance of zooplankton hot spots, determining the role of zooplankton in biogeochemical cycling, identifying processes that control of biodiversity and biocomplexity in zooplankton communities, and developing predictive capabilities for zooplankton distribution and function in a changing ocean. Moreover, the controllable collection of other particles such as non-bio plastics from the ocean can help to clear the marine environment and render it more suitable for organisms such as the phytoplankton to thrive and absorb chemicals like carbon dioxide.

The distributions of zooplankton in deep water and processes controlling these distributions and their dynamics remain poorly known, in part due to the challenges of sampling these systems with adequate spatial precision and sample size. Currently, no subsea sampling equipment is in use that has the capability to selectively sample and collect particles or to do so in a manner that does not damage the particles. Historically, towed plankton-net sampling systems have been in use in oceanography since the 1970s to map the depth-stratified distribution of pelagic organisms with simultaneous collection of information about the physico-chemical environment, but these systems have severe drawbacks that limit their effectiveness. The MOCNESS (Multiple Opening-Closing Net Environmental Sensor System) has been a gold standard for decades and was recently used extensively by the international Census of Marine Life CMarZ program. MOCNESS has also been used for distributional studies of deep-sea larvae at hydrothermal vents and methane seeps. In general, the MOCNESS is a system of multiple opening-closing nets typically lowered to within 50 m of the seabed and towed obliquely to the surface to obtain low-spatial-resolution samples that integrate across tens of meters water depth. FIG. 1 depicts a typical path through the water column of a MOCNESS oblique tow.

For a typical full water-column sampling program, the MOCNESS is towed obliquely from the lowest safe limit of bottom approach (typically 50 to 100 m above bottom) to 100 or 200 m below the surface. A large (0.25 m² to 10 m², depending on the system) net opening ensures that a large volume of water (up to thousands of cubic meters, depending on ground speed and time a net is left open) is processed through each net, but each sample is necessarily integrated over large vertical and horizontal distances (FIG. 1), obscuring information on fine-scale spatial distributions and processes. Furthermore, the towed character of the net system precludes the possibility of sampling effectively the near-bottom (<50 m) strata. A net-based sampling method for deep-submergence vehicles (e.g., Deep Tow and Alvin) was developed and deployed in multiple deep-sea settings. But these systems have severe limitations in that they cannot operate at close proximities to the ocean floor as it would become entangled with plants and other physical structures on the seafloor and will collect samples from numerous strata in a single collection without differentiation. Additionally, MOCNESS operates in a towed fashion and therefore can only move over long distances towed at an angle form the surface. These deficiencies prohibit the finding of particle distribution based on depth, prevent the ability to collect samples from areas near the ocean floor, and prevent concentrated collection of a small area.

In addition to MOCNESS and similar opening-closing net systems, a variety of other plankton sampling systems have been used to build our understanding of plankton distributions, including imaging systems such as the Video Plankton Recorder, the Underwater Vision Profiler, and Light On-Sight Keyspecies Identification (LOKI). For near seabed systems, in situ large-volume plankton pumps and larval traps are a proven method of sampling zooplankton at precise locations near the seabed and have the valuable capability of time-series sampling. Prior results with larval traps at chemosynthetic ecosystems suggest that abundances of larvae are significantly higher within 5 m of the seafloor than 50 m above the seafloor.

Furthermore, existing sampling systems have struggled to retain sampled particles undamaged and in the case of organisms, alive, during collection. This is primarily due to the pressure forces exerted by the movement through the water, particularly the bow wake, which often shred the particles and organisms or at least a substantial amount thereof. Previous systems have failed to balance these pressure forces on the filter means. The present invention provides an apparatus specifically designed to balance these forces and sample a range of highly delicate organisms and particles as close to their natural state as possible.

There remain critical gaps in plankton sampling and environmental sensing capabilities, including precision sampling at variable, narrow, and spatially constrained depth strata, particularly in conjunction with a suite of remote sensing and sensor packages that offer information vital to the parameters of the collection. There is also a particular need for near-bottom sampling in regions of chemosynthetic seeps and vents, cold-water corals, sponge gardens, and other patchy benthic habitats, where larval densities are reported to be maximal. For these and other ecosystems, the understanding of how populations are maintained benefits from knowledge of details of larval dispersal and distribution over space and time and with geochemical and geophysical characters of water masses and strata.

The instant invention seeks to address one or more of these issues in various embodiments and to provide significant advantages over the prior art. The instant invention comprises a large-volume sampler (for bio-particles such as plankton and non-bio particles such as microplastics and other plastic particles) compatible with underwater vehicles such as the autonomous underwater vehicle Sentry (Woods Hole Oceanographic Institution) that allows for the controllable collection and sampling of particles subsea particularly in deep water and near the seafloor.

### BRIEF DESCRIPTION OF THE DRAWINGS

The drawings constitute a part of this specification and include exemplary embodiments of the Aquatic Sampler and Collection Apparatus, which may be embodied in various forms. It is to be understood that in some instances, various aspects of the invention may be shown exaggerated or enlarged to facilitate an understanding of the invention. Therefore, the drawings may not be to scale; instead, emphasis has been placed upon illustrating the principles of the invention. In addition, in the embodiments depicted herein, like reference numerals in the various drawings refer to identical or near identical structural elements.

FIG. 1 is a typical path through the water column of a MOCNESS oblique tow.

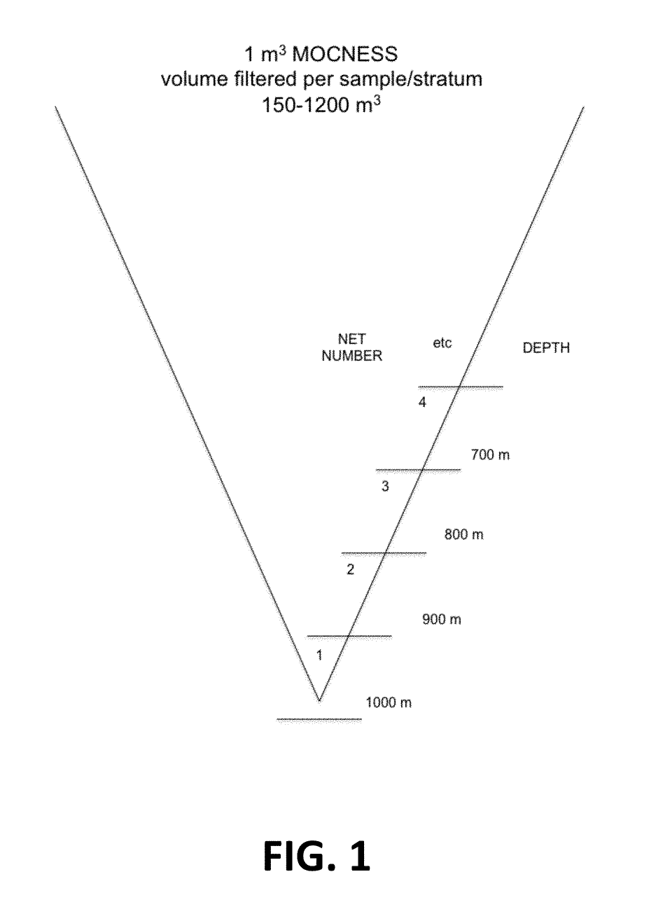

FIG. 2 is an illustrated embodiments of the SyPRID 3D models. A) Side view of a single unit with cut away to show interior view of intake valve, filter tube, cod end, and axial flow pump; B) Double unit and saddle mount bracket; C) Section view of cod end and sample filter plate.

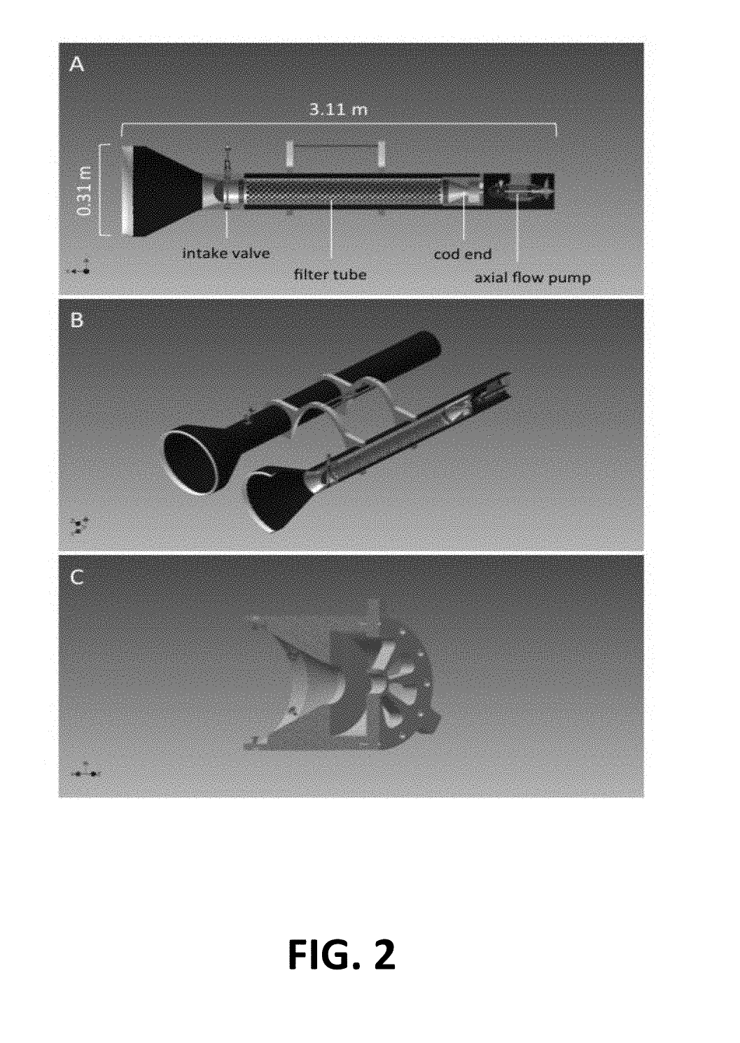

FIG. 3 is an illustrated embodiment of the SyPRID installed on Sentry with saddle brackets. A) On deck in cradle; B) Test dunk prior to sailing.

FIG. 4 is an illustrated embodiments of the SyPRID components. A) In-line valve; B) Filter; C) Filter detail; D) Cod end; E) Sample mesh; F) Axial flow pump.

FIG. 5 is an illustrated embodiment of the sample processing. Filter and cod end are washed down, then filter is removed, cod end is removed, and the sample filter is washed into a sample bucket.

FIG. 6 is a latitude/longitude plot of Sentry/SyPRID 322 survey track based on post-processed navigation; black track: altitude 5 m; blue track: altitude 80 m to 5 m. The survey track is underlain by Sentry-generated high-resolution bathymetry (1 m grid) together with benthic coverage of mussels (red and blue circles) and the area occupied by clams (gray outlines) were generated from Sentry photosurveys. The full photosurvey area, including non-seep habitats, is outlined by the dashed white line. Bathymetry and photosurveys were conducted during E/V Okeanos Explorer EX1205L1.

FIG. 7 is a time series plot of five of the basic sensors on Sentry, from top to bottom, temperature (° C.), salinity (psu), optical backscatter (V), dissolved O₂ (μmolar), and oxidation-reduction potential (dORP/dt).

FIG. 8 is a representative condition of soft (A) and shelled (B) larvae collected by SyPRID. A: mitraria larva of an oweniid polychaete; B: larva of a corbiculid bivalve.

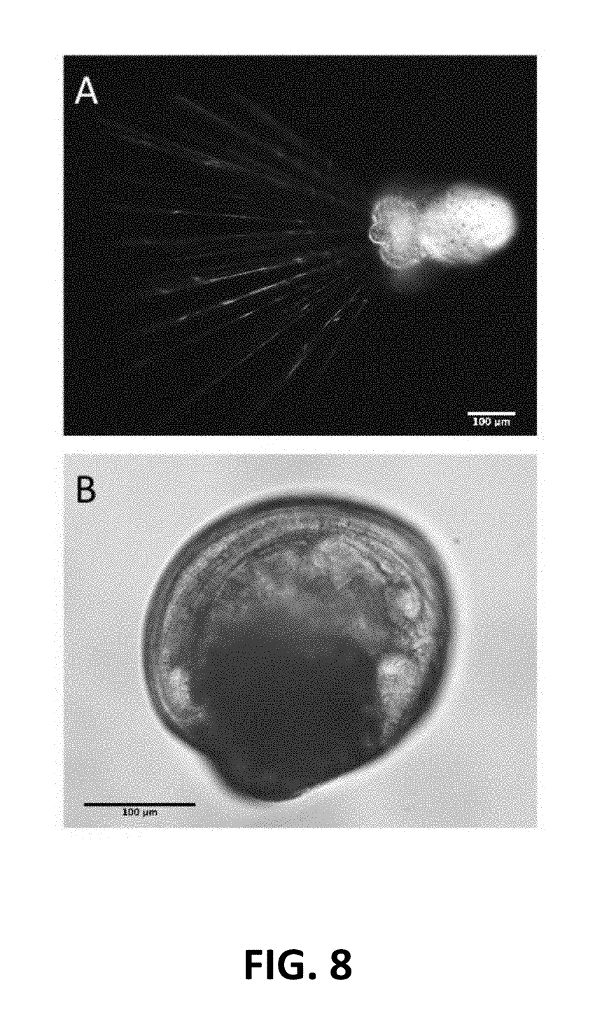

FIG. 9 is a labeled depiction of a SyPRID embodiment of the instant invention showing a side cross section of a sampler unit mounted to a Sentry vehicle.

FIG. 10(a) is a diagramed cross section of a sampler unit similar to the embodiment in FIG. 9. FIG. 10(b) is an in-line view of the sampler unit looking in from the front. FIG. 10(c) is an aft in-line view of the same sampler unit.

### DETAILED DESCRIPTION OF THE ILLUSTRATED EMBODIMENTS

The subject matter of the present invention is described with specificity herein to meet statutory requirements. However, the description itself is not intended to necessarily limit the scope of claims. Rather, the claimed subject matter might be embodied in other ways to include different components or combinations of components similar to the ones described in this document, in conjunction with other present or future technologies.

Furthermore, the described features, structures, or characteristics may be combined in any suitable manner in one or more embodiments. In the following description, numerous specific details are provided, such as examples of aquatic vehicles, propulsion means, connection means, sensors, filters, tubing, and uses of the system. One skilled in the relevant art will recognize, however, that the Aquatic Sampler and Collection Apparatus may be practiced without one or more of the specific details, or with other methods, components, materials, and so forth for numerous uses. In other instances, well-known structures, materials, or operations are not shown or described in detail to avoid obscuring aspects of the invention.

An aquatic sampling and collection apparatus is provided herein comprising generally a tube within a tube cylindrical collection system wherein an inner filter tube is housed within an outer collection tube wherein the outer collection tube has a front end that is flared in a frustum shape to collect water. The inner tube defines an open or at least partially open chamber lined with a net, membrane, filter, or other collection means which concludes with a conical cod end. An axial flow pump (or suitable pumping means) is situated within the collection system to facilitate the movement of water, generally in larger volumes (e.g., flow rates of at least 100 m³/hr, preferably about 500 m³/hr, more preferably about 1,000 m³/hr, 1,500 m³/hr, up to 2,000 m³/hr, up to 3,000 m³/hr), through the system thereby drawing particles in to be collected. The apparatus is paired with a subsea vehicle that allows for controlled collection and sampling. In various embodiments, the apparatus can be used to collect both bio particles such as plankton and non-bio particles such as plastics from the aquatic environment (e.g., ocean). Where sampling is desired, the apparatus may include a disk after the conical cod end upon which the samples are collected.

The present invention describes the systems and methods for the high-volume collection of plankton including macroplankton, mesoplankton, meroplankton, microplankton nanoplankton, harmful algal blooms (e.g., Alexandrium, Karenia, Pseudo-nitzschia), animal larvae, marine snow, microorganisms, or other particles (bio or non-bio) such as microplastics and other plastics or non-bio particles. The systems described herein are adapted to sample from the deep ocean (e.g., depths of up to 50 m, 100 m, 200 m, 300 m, 400 m, 500 m, 1,000 m, 1,200 m, 1,400 m, 1,600 m, 1,800 m, 2,000 m, 2,200 m, 2,400 m, 3,000 m, 4,000 m, 5,000 m, 6,000 m, 8,000 m or even greater depending on the circumstances) using a novel sampling and collection device mounted on an aquatic vehicle or platform capable of maneuvering subsea such as a Remotely Operated Vehicle (ROV; light workclass ROV, heavy workclass ROV), an Autonomous Underwater Vehicle (AUV), a Hybrid Remotely Operated Vehicle (HROV), a Human Occupied Vehicle (HOV), a glider, a submarine, a mini-submarine, an underwater observatory, a mooring, or other suitable vehicles or platforms.

One such example of a suitable aquatic vehicle includes the Sentry AUV by Woods Hole Oceanographic Institution. When paired with the Sentry AUV, the system is referred to as the SyPRID (Sentry Precision Robot Impeller Driven) sampler, which will be discussed herein as an illustrative example of the present invention. Sentry was chosen as a test vehicle because it routinely conducts mission-specific surveys with precision horizontal and vertical navigation to within 5 m of the seabed, and with co-registered geochemical, geophysical, photographic, and acoustic sensor data collection. Sentry missions 248, 249, and 251 in the Gulf of Mexico (R/V Atlantis AT26-15) demonstrated a new survey capability for precision, three-dimensional flight at 120 cm above the seabed. This capability pre-adapted Sentry to attempt plankton-sampling missions in the critical high-larval-density regions near the seafloor in chemosynthetic and other benthic habitats with a new type of plankton sampler. The SUPR pump sampler and Sentry have been successful in sampling abundant larvae from surface waters in coastal areas, but the low pump rate (˜2 L min⁻¹) did not sample an effective volume to capture larvae nor was it able to collect the larvae alive on extended Sentry surveys at altitudes of 50 m, 20 m, 5 m, 3.5 m, 2 m, 1.2 m, 1 m, and 0.5 m above bottom, in deeper waters where larvae are more scarce.

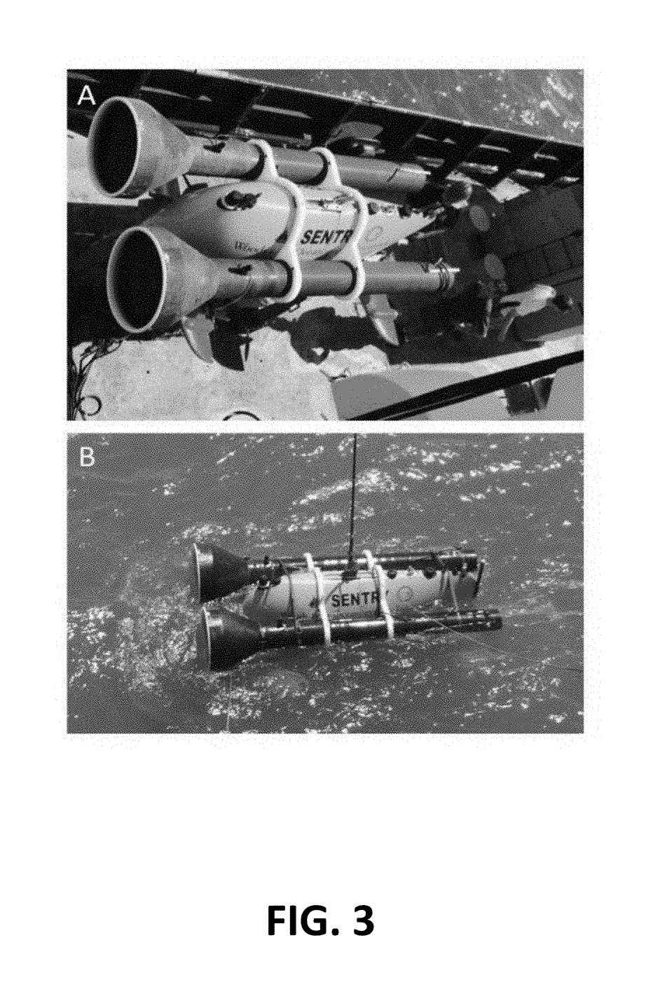

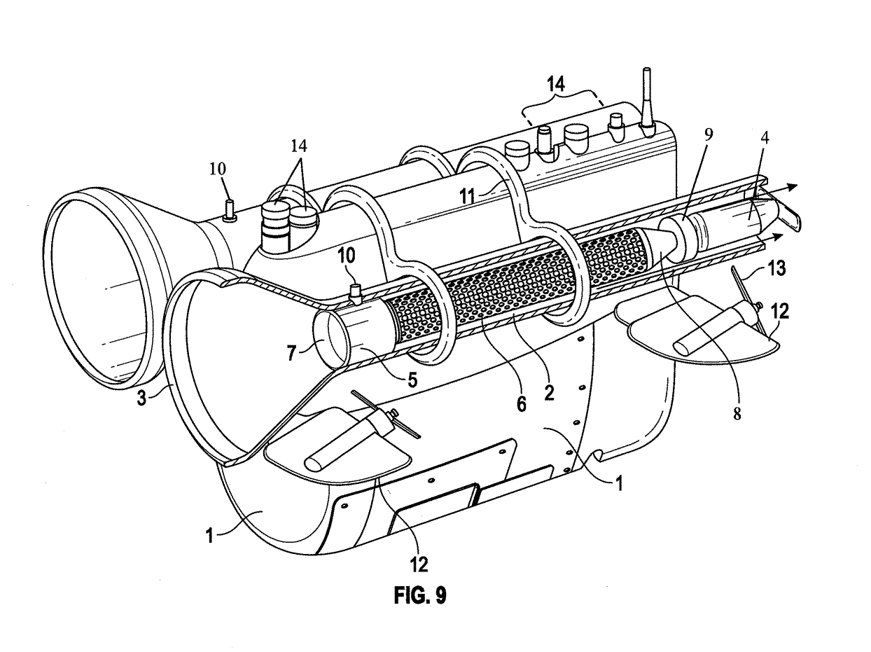

While the Sentry is discussed herein along with the SyPRID embodiment, it is to be understood that various different aquatic vehicles and platforms can be used with the present invention and that the use of the SyPRID as an illustrative example throughout this disclosure should in no way limit the scope of the instant invention. In fact, a person having ordinary skill in the art that understands the instant invention would comprehend that numerous aquatic vehicles can be paired with the sampling system disclosed herein to create a fully functional apparatus so long as the aquatic vehicle is capable of maneuvering in an aquatic environment, preferably capable of maneuvering at depths greater than 50 m, and capable of allowing sampling near the floor of the aquatic environment (e.g., within 50 m or less, 10 m or less, 5 m or less). The maneuverability of subsea vehicles is well understood in the art. Therefore, the functionality of the subsea vehicle itself will not be discussed in great detail herein except to note that, as depicted in FIGS. 3 and 9, aquatic vehicle 1 is a Sentry AUV that employs a system of rotatable, articulated wing members 11 with attached thrusters 13 in the form of propellers to controllable maneuver through the marine environment.

As previously discussed, traditional net-based sampling tools limited researchers' ability to study underwater particles and life forms, such as deep-sea larval distributions, because the samplers were not able to get closer than 50 m to the sea bottom and could only move over long distances towed at an angle from the surface. Such systems are designed to be towed by a vessel and are unsuited for autonomous sampling and for sampling at discrete depths in the water column. The instant invention solves these issues in several embodiments by mounting an innovative sampling device to a subsea vehicle which is capable of delivering the device to the location where sampling and collection is desired, thereby controlling the collection of particles. An aquatic vehicle capable of traveling to deep water such as the Sentry allows the improved sampling device to reach to within two to three meters (or less, in some cases) from the water bottom (e.g., ocean bottom, seabed, lake bed) and at least within five meters of any desired point or pattern of points in more than 95 percent of the world's water sources (e.g., oceans, lakes, ponds). Additionally, the ability to choose a precise position or portion of the water column to sample rather than the entire water column when returning to the surface from collecting samples is highly advantageous and offers great control in sampling.

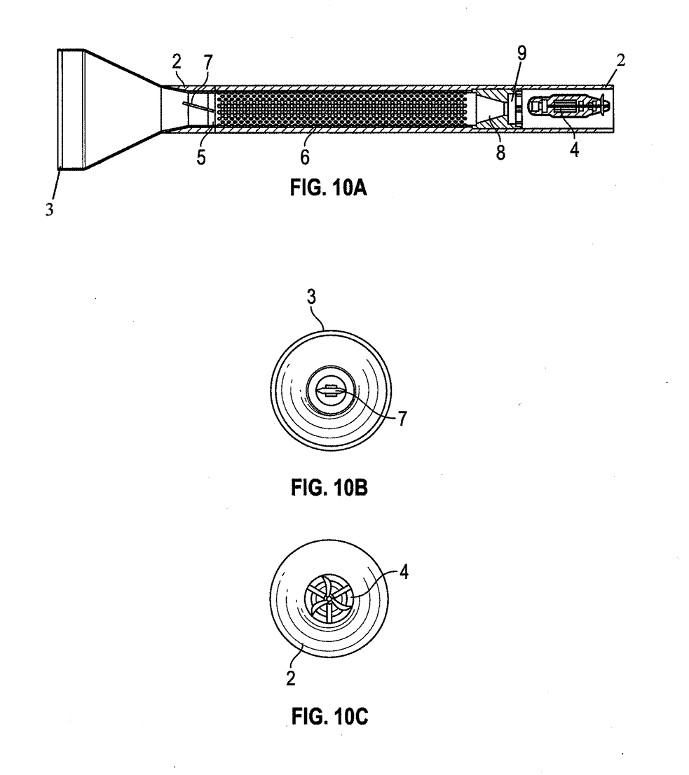

Turning to FIGS. 9 and 10, in general, the sampling and collection apparatus disclosed herein as sampler unit 0 comprises a tube within a tube collection system with an outer collection tube 1 and an interior filter tube 2 that is capable of being housed within the outer collection tube. A tube is defined as a structure generally cylindrical (however other shapes and dimensions may be accommodated) with at least one end adapted to open which may also include one or more channels, pathways, chambers, and any other suitable transport means to provide a path for the flow of samples into the sampler unit 0. In several embodiments, the outer collection tube comprises at least one inlet adapted to allow fluids to enter the apparatus and at least one outlet. The outer collection tube 1 is generally elongated and may be matched to the intended vehicle or platform of use which may be up to 20 m in length or more in some cases. In many embodiments, the outer collection tube 1 is less than 10 m, less than 8 m, less than 5 m, and in the example herein is approximately 3 m long. Typically, tube 1 is greater than 1 m long to accommodate the necessary flow and pressure forces needed to reliably sample delicate particles.

In some embodiments, at least a portion (e.g., a quarter, half, three quarters, whole length) of the interior tube is capable of being housed within the outer collection tube. The interior filter tube 5 is typically shorter in length and accommodated within the outer collection tube 2; however, in certain embodiments the interior filter tube 5 may extend through the entire length of the outer collection tube 2. The interior tube generally comprises a front opening (e.g., inlet), at least a portion of which may be engaged with the fluid blocking means (described in more detail below) to control the entrance of fluid from entering the interior tube. In another embodiment, fluid in controllably blocked from entering the interior tube by a fluid blocking means engaged with the outer collection tube 2.

Unlike sampling devices used in the past, which often damaged the delicate planktonic specimens they collected, the instant invention uses an axial flow pump 4, which as illustrated is in the form of spinning blades, inside the aft portion (e.g., close to or near the outlet of the system, near or positioned past the middle section of the tube) of the tubes. In another embodiment, the flow pump 4 is located at any position within the tube (e.g., interior filter tube) including the proximal quarter, the proximal half, the distal half, and the distal quarter of the tube. In other embodiments, the flow pump 4 is attached external to the outer collection tube which can allow for a longer inner filter tube) to gently pump large volumes of water, and the microscopic organisms or particles contained in the water, into and through the sampler unit tubes. The water passing through the unit flows through the filter system within the unit whereby particles are collected. In embodiments set up for sampling of microorganisms, the use of a system like the SyPRID allows the microorganisms, even highly delicate unarmored, soft-bodied larvae, to be filtered gently within the sampler system as to remain intact (e.g., alive, undamaged). Some of the organisms being sampled are surprisingly mobile and if they become alarmed by the sampling process will attempt to escape the flow path. This is a consideration for reducing bias in sampling and therefore using a system designed for gentle collecting is key to obtaining an accurate representation of the particle population. Additionally, it is an object of several embodiments of the present invention to provide a sampler which maintains the integrity of the collected sample for further scientific analysis such as imaging, species isolation, genetic analysis (mRNA expression, protein expression), or the like. In many embodiments, the sampler unit 0 is capable of sampling organisms in a gentle manner such that most organisms remain intact and alive. In specific embodiments sampling organisms, at least 10%, 30%, 40%, 50%, 60%, 70%, 80%, 90%, 92%, 95%, 97%, 99%, and up to 100% of sampled organisms are intact, are undamaged, and/or are alive.

In greater detail, the sampler unit 0, which is mounted to aquatic vehicle 1 via harness 11, comprises a tube within a tube (or structure within a structure) construction made of an outer collecting tube 2 and an inner filter tube 5. The outer collecting tube 2 is an elongated cylindrical tube that is open on both ends. The front or bow portion of outer collecting tube 2 flares outwards to form a frustum shaped inlet 3 that allows for large volumes of water to be pulled into the sampler unit 0 by the axial flow pump 4 located in the aft section of outer collecting tube 2 before the tube's outlet. The inlet extends inwards towards a substantially diametrically consistent cylindrical tube that forms outer collecting tube when paired with the inlet. On the distal end from the inlet 3, outer collecting tube 2 terminates in an open outlet to allow water to flow out of the unit. The outlet may also comprise a means to close to prevent water from flowing out of the system.

Water and particles flow in through the inlet 3 into the chamber defined by the portion of outer collection tube 2. While traveling through the chamber, the water and particles flow through and contact a filter means located in the chamber such that the particles are collected while the water flows through. As depicted, filter tube 5 serves as the filter means and is a perforated cylindrical column of relatively constant diameter throughout. The bow of front end of the tube is open to allow for the fluid comprising water and particles to flow from the collecting tube 2 into the filter tube 5. The walls of the filter tube are generally lined with a mesh net 6 or membrane with a pore size selected to correspond with the size of the particles that are to be collected. For example, in plankton sampling, it may be desirous to utilize a membrane 150 μm, which is the general size that has been traditionally used with net sampling such as through MOCNESS. Different mesh sizes can be used if desired, including pore sizes of 50 μm to 100 μm, 100 μm to 200 μm, 200 μm to 500 μm, and up to 1 cm or more, and indeed will likely be used for non-plankton sampling and collection. For example, if the unit was calibrated to collect only larger plastic particles such as those of 0.25-0.5 centimeters, the perforations in either the mesh net 6 or the filter tube 2 itself would be sized at or near 0.25 centimeters. This would allow substantially all particles smaller than 0.25 centimeters to pass through the net mesh 6 and filter tube 2 and pass out of the aft outlets of the sampler unit 0. It is important to note that the mesh size correlates with drag and resistance and, therefore, can have an effect on the amount of water pumped thru the system. Therefore, the flow rate of the system may need to be calibrated by adjusting the velocity of the vehicle 1 and/or the axial flow pump 4 to ensure the desired flow rate for the application.

In alternate embodiments, filter tube 5 may have sufficiently sized perforations such that it acts as the net unit itself, or otherwise, it may not have any perforations except on its distal end. Additionally, it is possible for the inner filter tube to be replaced entirely by a net or membrane depending on the function of the embodiment. Inner filter tube 5 is a filtering means that diametrically smaller than outer collecting tube 2 so as to fit inside the outer tube. As depicted, inner filter tube 5 is a perforated plastic tube that allows for water to flow through it; however, the tube itself, like most of the components in the sampling unit 0 can be constructed of numerous types of materials such as various plastics, metals (e.g., steel, steel alloy, titanium, aluminum), carbon fibers, and the like. Depending on the application and the capacity of the underwater vehicle, weight, and buoyancy may be issues that have to be factored when choosing the appropriate materials for the specific application.

The aft portion of filter tube 5 terminates in a cod end comprising cone 8 and disk 9 through which water can still pass. A person with skill in the art would recognize that the disk 9 and cone 8 function similarly to a cod end, which is a nautical term for the narrow end of a tapered trawl net. Thus, although the chassis of the inner filter tube 5 is substantially consistent in diameter throughout the tube, the outlet diameter of the inner filter tube 5 is gradually decreased in the aft portion cod end structure as water is funneled through cone 8 so as to push the fluid containing water and particles into contact with disk 9 upon which the particles are gently deposited. In similar embodiments, the filter means is a filter tube with a diameter which decreases over the length of the tube. In other embodiments, the filter means is any suitable device capable of retaining particles from the water flow while allowing the particles to continue a trajectory toward disk 9.

In general, disk 9 is constructed to receive the sampled particles and retain them without unnecessary damage while allowing water to pass. As depicted, the disk 9 is generally a mesh disk that has a porous diameter chosen to catch particles of a desired size while allowing smaller particles and fluids to pass through. In other embodiments, the sides of disk 9 are porous to allow the water to flow through. Any portion of disk 9 may be constructed to pass water through so long as the desired sized particles are collected. Again, for plankton sampling, the accepted size is about 150 μm. Although the disk is depicted as an annular structure, the disk may be any suitable means, dimension, or size to retain a sample, specifically a delicate sample. In embodiments of the subsea sampler unit 0 wherein the particles are non-bio or it is otherwise not important to maintain the integrity or life of the particles collected, the cod end cone 8 and disk 9 may be modified or entirely removed as their function is primarily to reduce stressful impact of the particles during collection. Disk 9 is generally removable and may be an exchangeable or even disposable cartridge in order to facilitate the collection of uncontaminated samples between different missions. In other embodiments, disk 9 is a permanent or integrated component housed in the outer tube (or inner tube) which may be cleaned, rinsed, or otherwise removed of sampled particles. In additional embodiments, disk 9 is permanently engaged with the outer tube (or inner tube) and is adapted to receive an inserted filter or other collector, sieve, strainer, mesh, screen, membrane, etc. which is removable and/or disposable.

In some embodiments, the mesh or any other surface of the filter means (or the mesh of the inner filter tube) is coated with a coating or resin which helps maintain the particles to the mesh or other surface by ionic charge (e.g., static charge) to reduce movement and potentially damage of the sampled particles. Such coating may include polyurethane, acrylic urethane, epoxies, thermoplastic polymers (e.g., polyesters, polyethylene, polypropylene, polystyrene, polyvinylchloride, polyamides, polyphenylene oxide, polysulfones, polyaryl ethers, polyaryl sulfones, polycarbonates, polyurethane, polyacrylates such as polymethyl methacrylate, polymethyl acrylate, and polyacetyls), and any similar coating or mixture as known in the art.

The disk may comprise one mesh surface (e.g., membrane, filter, webbing, screen, netting, film) which collects the sampled particles. However, in other embodiments, the disk may comprise more than one mesh surface, each separated by a volume of space so as to be capable of selecting and capturing specific sized particles as water flows through the system. In such cases, the mesh surfaces may be arranged so that the mesh comprising the largest pore size first contacts the sampled particles and every sequential mesh thereafter reduces in pore size so that the mesh with the smallest desired pores contacts the sampled particles last to retain the smallest particles. This results in an organized arrangement of sampled particles based on size. Additionally, the sampler unit may comprise more than one disk aligned sequentially, each with a varying sized mesh to receive specific sized particles. As water flows into the first disk, it may then pass through to the second, and continue through subsequent disks until reaching the outlet.

Although some fluid will enter the sampling unit 0 during the sampling period as the aquatic vehicle moves through the water, the system further comprises a flow assurance means which is an axial flow pump 4 designed to pull water into and through the sampling unit 0. As depicted, the axial flow pump uses an impeller such as a propeller available from Torqeedo GmbH driven by a mechanical motor such as a direct drive thruster or any suitable flow-generating means such as the Improved-Efficiency Submersible Thruster (Patent Application No. PCT/US2015/037548) that is located in the aft portion of the sampler unit 0 so as to pull fluid into the unit through inlet 3 into the body of outer collecting tube 2 wherein at least a portion of the fluid will pass into inner filter tube 5. A suitable impeller generally comprises at least one fin or blade (as described in PCT Application No. PCT/US2015/023970), often 2 fins, 3 fins, 4 fins, 5 fins, 6 fins, or more depending on the desired force generated to pull water through the apparatus. Such fins may have a rake angle of 0 degrees to 45 degrees, 5 degrees to 40 degrees, and 15 degrees to 30 degrees which is to say the amount of degrees a propeller fin is angled perpendicular to the hub to which it is attached. Additionally, the fins may be symmetrically or asymmetrically distributed about the hub.

The fluid will continue to be pulled through filter tube 5 such that it will flow through the porous sides of filter tube 5 and the cod end while the particles of sufficient size will be trapped within the filter tube 5 unit by the net mesh 6. These particles will remain in the filter tube but will be pulled towards the cod end by the flow of the fluid such that some of the particles will enter the cod end cone 8 and be collected on disk 9. As will be discussed in the example below, the flow assurance means acts to pull fluid into the system and continue and assure the flow through the system thereby separating and collecting the particles of sufficient size. Additionally, however, it can also help to reduce the bow wake caused by the inlets. As known in the art, bow wake or waves create a streamlined force by the movement of water which can be particularly destructive, shearing sampled particles and organisms by force. Thus, the design of the apparatus must effectively reduce such forces upon the sampled material while the samples enter the inlet, while they pass through the filters, while they are stored in the unit, or any combinations of the above depending on the embodiment. While the axial flow pump used herein comprises an impeller, it is readily understood that various other configurations can be used to pull water into and through the unit. This can be facilitated by pumps, waterjets, turbines, and other fluid moving apparatuses as would be recognized by one having skill in the art. The inlet is shaped and sized to create a velocity slightly larger than that of the vehicle. We closely match the velocity of the inlet and that of the vehicle. This helps prevent a bow wake and any disturbance in the water while allowing us to filter large amounts of water.

Of particular value in the present invention is the capability of some embodiments to sample very close to the floor of the aquatic environment. As mentioned above, the forces generated by moving water through the apparatus can cause unnecessary shear stress on the sampled particles. Additionally, these water forces can also induce a substantial amount of sediment resuspension near the floor which can clog small sample inlets. The inlet 3 of the present invention is designed to be considerably larger than existing systems which in turn reduces these forces both in and out of the system and allows the apparatus to sample waters very close to the floor (e.g., within 5 m or less) with little to no resuspended sediment.

As previously indicated, it is often desirable to control the collection of particles and specimen to certain areas in the water such as particular strata, depth, or physical location. In order to prevent the collection of particles en route to or from the desired location, the sampler unit 0 employs a fluid blocking means 7 to prevent fluid from entering at least the inner filter tube 4, if not the entire unit. For example, the blocking means 7 could be placed substantially near the bow end of the inlet 5 so as to prevent fluid from passing into the unit entirely as opposed to just the inner filter tube. In some embodiments, a second blocking means 7 may be integrated to prevent any water from leaving the system such as near the outlet or in the cod end to prevent any water from entering the disk. As depicted, however, blocking means 7 is an in-line valve in front of the filter tube 5 that can be controllably opened to allow for collection or closed to prevent contamination of samples at the surface and during ascent and descent. Although the blocking means 7 is depicted as an in-line valve similar to a butterfly valve, numerous types of valves such as ball valves, gate valves, disc valves, knife valves, pinch valves, plugs, plug valves, spool valves, gates, sampling valves, and globe valves can be employed. As shown in FIG. 9 specifically, the sampler unit 0 may also comprise a funnel valve 10 to allow fluid to pass out of the inlet 3 when the valve 7 closes the passage to the interior filter tube 5.

The fluid blocking means 7 may be controlled to open and sample during a desired time period as set by predetermined program prior to system deployment, may be remotely operated to begin and end the sampling period by a user aboard the operating vessel or at a land facility, and/or may employ adaptive sampling by initiating and/or ending the sampling period in response to a change in a parameter of interest, including but not limited to, a chemical signal (e.g., harmful algal bloom, petroleum or crude oil, dissolved oxygen, dissolved carbonate, nitrogen, pH), an environmental parameter (e.g., salinity, temperature, pressure, depth, seismic vibration, density, ocean circulation patterns, etc.), reduction-oxidation anomalies, and/or a visual clue when a camera or other imaging system is integrated. In such embodiments employing adaptive sampling, the apparatus typically measures one or more parameters of interest, compares the measurement(s) to one or more set thresholds, and initiates or ends the sampling period based on those threshold comparisons.

The apparatus is generally capable while sampling in motion and may adjust the speed of the flow pump means to ensure that the pressure forces exerted on the particles remain at a level low enough to prevent particle damage (e.g., less than 10 psi, less than 5 psi, less than 2 psi, 1 psi or less). Additionally, the apparatus may be adapted to sample while stationary, typically relying on the flow pump to pull fluid and particles in the system. In another embodiment of stationary sampling, the apparatus utilizes a water current sensor or similar device to measure the flow of fluid outside of the system and may adjust the speed of the flow pump accordingly. When sampling resilient bio and non-bio particles such as plastics, the flow speed into the inlet may be increased to allow more fluid to be processed as higher pressure forces can be tolerated.

As depicted in FIG. 9, the SyPRID is a dual sampling unit system wherein two sampler units 0 are harnessed onto the aquatic vehicle 1 via attachment means 11 which is a detachable harness. The harness securely mounts one or more sampler units to a vehicle or other platform and arranges the sampler unit(s) at a suitable position where bow wake will have little to no impact on the sampled particles. This position may precede the front of the vehicle or may be positioned in line with the front of the vehicle although the intended velocity of the vehicle and the desired speed of sampling should be taken into account as to not increase the pressure forces and negatively impact the sampled particles. The harness typically mounts the sampler unit(s) on the top of the vehicle, however the sampler unit(s) may be attached at any suitable position particularly closer to the bottom of the vehicle where very near seafloor sampling is desired. In various embodiments, the attachment means can be either removable such as to allow for easy maintenance of the units, for storage, or to repurpose the aquatic vessel, or the sampler unit can be permanently attached. Thus, the attachment means comprise any number of fasteners or other means well known in the art that can include harnesses, straps, bolts, welding, mechanical fasteners, and water-safe adhesives to name a few. One having ordinary skill in the art would readily recognize numerous other means of attaching sampler units such as those disclosed herein to an aquatic vehicle. It is further readily understood that while a dual sampling system is depicted, embodiments can be made that employ one or more samplers (e.g., 2 samples, 3 samplers, 4 samplers, or more), or that the one or more samplers can be positioned in a different location than the top of the aquatic vehicle.

As discussed herein, the instant invention takes advantage of major strides in autonomous vehicle design, including command and control, and it steps outside the box of towed net filtration systems. While MOCNESS and similar towed net systems will continue to play an important role in studies of pelagic zooplankton distributions, embodiments of the instant invention like SyPRID and its follow-on generations will enable tests of long-standing and emergent hypotheses regarding processes that control the distribution of plankton and planktonic productivity particularly in deep waters and near the floor of the aquatic environment. Furthermore, the invention provides for a great range of autonomous deep water (e.g., near bottom) sampling including, which far exceeds the capabilities of previous systems.

The instant embodiment is presented in terms of studies of larval dispersal and connectivity in patchy habitats, the combination of larval data with co-registered geochemical and physicochemical data (e.g., environmental parameters), benthic habitat maps, and planktonic community composition data simultaneously collected by the Sentry AUV will provide previously unobtainable insights into distributional patterns of larvae of benthic invertebrates and other planktonic form with respect to bottom features. One important long-standing question that SyPRID might resolve is the degree to which larvae originating in isolated chemosynthetic habitats are retained locally, corralled by mesoscale oceanographic features or are advected over long distances by predictable current patterns. Both processes may be acting in concert to maintain local populations (corralling) and facilitate gene flow (long distance dispersal). Resolution of this and related issues has implications for genetic exchange, phylogeography, community ecology, and conservation.

Salient issues in zooplankton research include understanding the formation, persistence, and significance of zooplankton hot spots, determining the role of zooplankton in biogeochemical cycling, identifying processes that control of biodiversity and biocomplexity in zooplankton communities, and developing predictive capabilities for zooplankton distribution and function in a changing ocean. While the basic components of a sampler unit 0 have been discussed, it is readily understood that additional parts and sensors could be paired with these components to improve upon the system for specific applications. The instant embodiment of the system was designed to provide new capability for studying these pelagic systems at new spatial scales and with correlative environmental data.

Accordingly, in various embodiments such as the SyPRID, the instant invention also pairs the apparatus with different sensors 14 that can be useful under the circumstances and specific applications that allow for the collection and sampling of particles, including adaptive sampling, to be coupled with the collection with environmental information at the time of collection such as readings on temperature, location, salinity, magnetics, depth, gravity, oxygen, carbon, nitrogen, or light, to name a few. Thus, thermometers, magnetometers, hydrometers, radar, depth sensors, gravitometers, oximeters, light meters, GPS, seismographs, Geiger counters, and salinometers may be mounted to the aquatic vehicle (or the sampler unit 0) such that they can be employed during collection.

Additionally, communication means such as antenna and modems or others known in the art may be installed and connected to a control unit such that the sensors and components of the sampling unit 0 can be remotely controlled from the surface or within the vessel. These sensors can either operate independent of the system to collect information or they can be paired directly with components of the system to act in concert with them (e.g., adaptive sampling). For example, the blocking means 7 (depicted as an in-line valve) can be paired with the antenna for a controlled activation that will either open or close the valve as desired. In other embodiments, the blocking means 7 can be paired directly with a sensor such as a depth sensor or GPS and programmed to open or close under certain collection parameters. For example, if the system is being used to collect particles at a strata of 100 m in a certain location zone, the blocking means may be paired with both the GPS sensor and the depth sensor so that the blocking means 7 remains closed during the travel to the area and descent to the depth, but will open once it is in the desired zone. Moreover, as the system is set to leave the area for a return trip, the sensors would trigger the closure of blocking means 7, thereby preventing contamination of the samples. Likewise, it may be advantageous in some situations to monitor and control the flow of fluids into the sampler unit 0. Therefore, a flow sensor such as an Acoustic Doppler Velocimeter (ADV) can be placed within a component of the unit (for example, either the outer collecting tube 2 such as near inlet 3 or the inner filter tube 5) to measure the flow through the unit. The ADV would provide real-time measured flow rate data. This flow sensor can in turn be paired with the axial flow pump 4 so as to increase or decrease the flow rate as necessary to keep a desired volume of fluid passing through the system. It may also be advantageous if a camera or video camera could be mounted onto the vehicle as an optical sensor 14 of sorts to provide visual depictions of the area where the sampler is used. Additionally, acoustic and/or optical modems (such as those described in U.S. Pat. No. 7,953,326) may be integrated with the present system as a means to communicate and/or transmit data including video acquired by the system to the operating vessel.

It is also possible that particles such as plankton or plastics may need to be sampled at various depths or collected throughout the strata of the marine environment. Thus, various embodiments can be built or configured to withstand the pressure at great depth. For example, the SyPRID sampler currently discussed is capable of submerging to a depth of more than 2,150 m (where pressure exceeds 3,150 psi) and performing a precise sampling pattern for more than 8 hours along the seabed such as around a natural methane seep or other underwater terrains. Of course, power sources can be modified to increase or decrease the operating capabilities of the system. The ability to sample at great depths is beneficial as the samples collected may comprise a plurality of various animals, microorganisms, etc. for the purposes of genetic or morphological studies or preservation that we were once incapable of reaching. The deep submergence sampler SyPRID allows further elucidation of the deep ocean environment and content and concentration of the larvae and microorganisms. Thus, further advantages of the inventive sampler can be noted in various embodiments with the ability to sample and collect from precise areas at great depths (e.g., 1,000 m, 2,000 m, 4,000 m, 6,000 m, 11,000 m, or more) for long time periods while filtering enough volume to find the relatively rare organisms in the water or collect a large amount of particles and plastics.

### EXAMPLE 1

The present invention provides the capacity for exploring the genetic, oceanographic, and larval connections among seep ecosystems and other underwater environments in addition to many other marine applications. The following example is put forth so as to provide those of ordinary skill in the art with a complete disclosure and description of the aquatic sampling and collection apparatus, and is not intended to limit the scope of what the inventors regard as their invention. Rather, it is meant solely to demonstrate a working embodiment of the invention.

A SyPRID embodiment of the present invention was tested in July of 2015 to collect plankton near natural methane seeps located in the ocean. Natural methane seeps play an important but poorly understood role in the ocean ecosystem. The organisms that depend on methane from the seeps play a substantial role not only in the marine food web but also in altering the quantity of methane released to the ocean surface and, potentially, in the overall chemistry of the ocean. Scientists lack a clear understanding of how sedentary or slow-moving animals move between the widely separated seeps, how new seeps are populated, and how resilient these ecosystems may be in the face of ocean change. Studying the microscopic planktonic larval stages of these animals may shed light on many of these processes.

The SyPRID embodiment of the sampler discussed herein was an innovative deep-rated (6,000 m) plankton sampler that partners with the Sentry AUV 1 to obtain paired, large-volume plankton samples at specified depths and survey lines to within 1.5 m of the seabed and with simultaneous collection of sensor data via sensors 14. SyPRID uses a perforated Ultra High-Molecular-Weight (UHMW) plastic filter tube 5 to support a fine mesh net 6 within an outer carbon composite collection tube 2 (tube-within-a-tube design), with an axial flow pump 4 located aft of the capture filter. The axial flow pump 4 facilitates flow through the system and minimizes the bow wake at the mouth opening. The cod end 8, a hollow truncated cone, is also made of UHMW plastic and is designed to ‘soften’ the landing of zooplankton on the capture surface (e.g., disk, filter, collection unit). SyPRID attaches as a saddle-pack to the Sentry vehicle via harness 11. Sentry itself is configured with a flight control system that enables autonomous survey paths to altitudes as low as 1.5 m from the seabed. In its inaugural deployment at the Blake Ridge Seep (2,160 m) on the US Atlantic Margin, SyPRID was operated for 8 hours at an altitude of 5 m. It recovered plankton samples from that stratum in excellent condition and with greater larval numbers than recovered in a typical ‘near-bottom’ MOCNESS sample from comparable habitats and depths. The prototype SyPRID and its next generations will enable studies of plankton or other particulate distributions associated with patchy habitats, localized physico-chemical strata (e.g., above and below the thermocline), or discrete water masses at an unprecedented spatial resolution for a large volume system.

### Overview of SyPRID Design Features

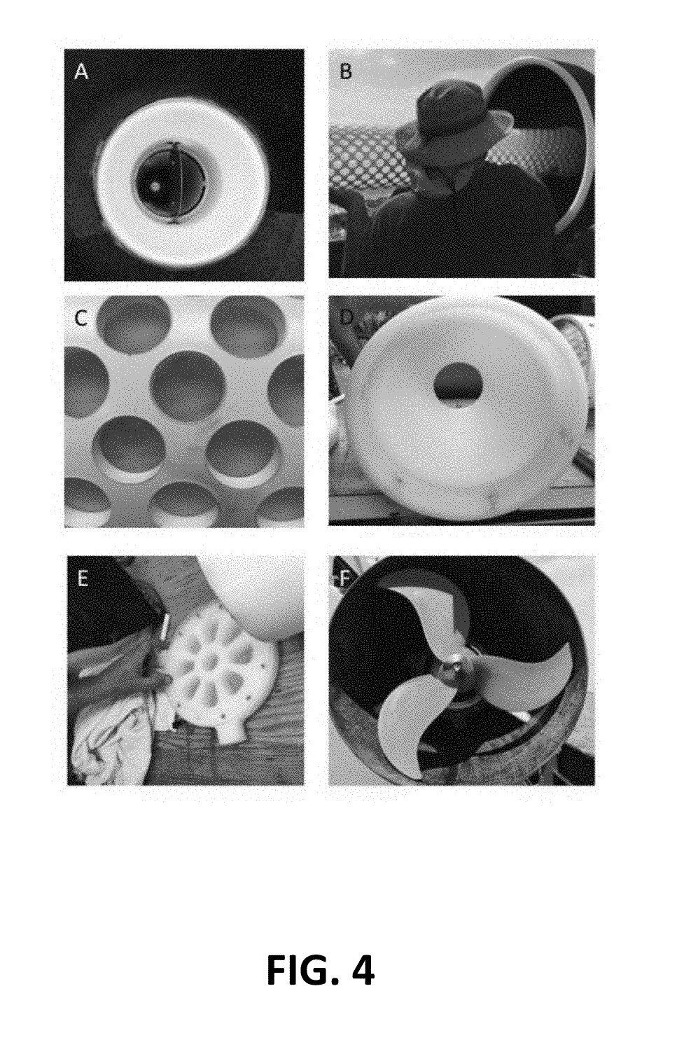

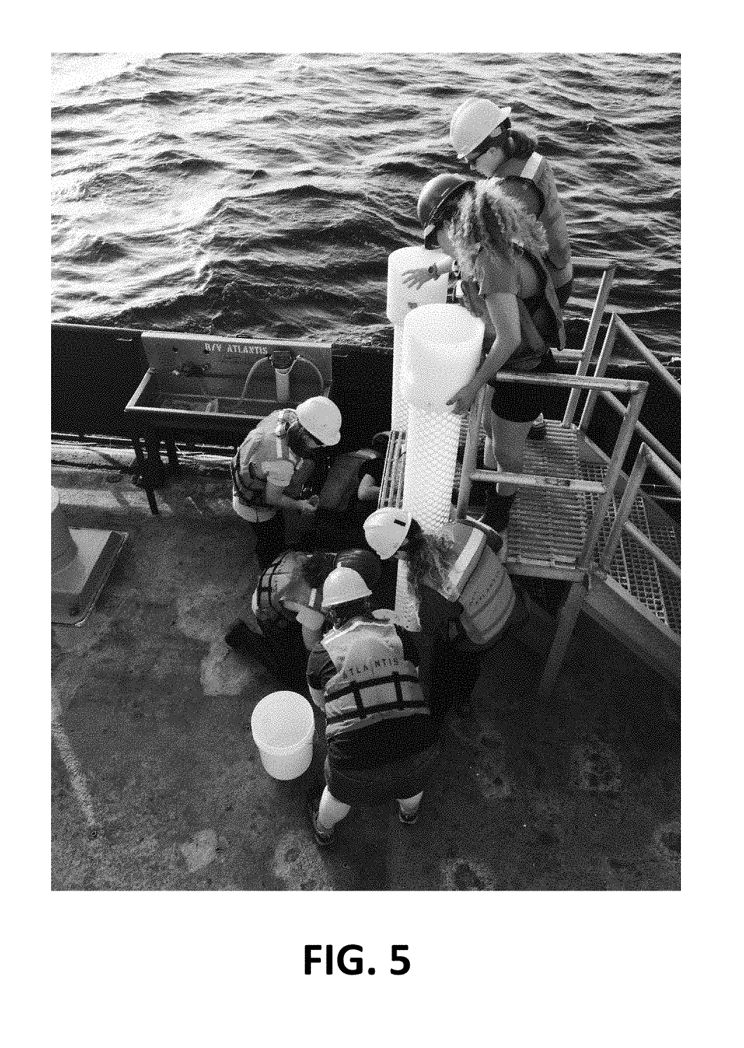

SyPRID is an embodiment of a paired sampling system with each sampler employing the tube-within-a tube design secured on the upper portion of the Sentry AUV using a saddle-pack harness 11 of UHMW plastic (FIG. 3). The overall length of the outer collection tube 2 of the tube system is 3.11 m. The outer carbon-fiber composite, outer collection tube 2 is flared (0.71 m diameter) at the inlet 3 and tapers to a cylinder (0.31 m diameter) sized to contain the axial flow pump 4 and to be accommodated by Sentry AUV 1. There is an in-line valve 7 in front of the filter tube 5 (FIG. 4A) to prevent contamination of samples at the surface and during ascent and descent. The filter tube 5 (which is also UHMW plastic) has an open area equal to the area of its inlet and is lined by a mesh net 6 which was Nitex Seafarer 150 μm mesh (FIG. 4B). The cod end 8 is a hollow truncated UHMW cone (FIG. 4C), with the narrow opening abutting the sample mesh disk 9 (FIG. 4D). In this embodiment, the axial flow pump 4 was an impeller unit. More specifically, a custom designed, direct drive thruster of the same type used for Sentry propulsion and with a Nereid-class propeller served as the axial flow pump 4 at the aft end of the system and distal to the sample mesh disk 9 (FIG. 4E). The internal cylinder and cod end are removable for sample processing (FIG. 5).

Sentry flies over the bottom using four thrusters 13 and four wings 12 which are actuated in pairs (fore and aft). This allows for exceptional maneuverability. When properly ballasted, Sentry is nearly neutrally buoyant, giving it a thrust-to-weight ratio sufficient to run at a very high angle of attack in a highly stalled regime. This allows very close bottom following at high average efficiency by flying in an unstalled regime except when a bottom impact is imminent—then the vehicle moves to a stalled regime. In effect, this is the underwater equivalent of transitioning rapidly and frequently between a fixed wing aircraft and a helicopter. The vehicle takes advantage of each mechanism as the situation requires. Stalled-unstalled regime switching enables very low-level flight in flat terrain, despite the minimal forward velocity, and it preserves mission duration.

Sentry uses a proportional/derivative (PD) controller with altitude provided by the same Doppler Velocity Log (DVL) sonar system that assists in vehicle navigation. Altitude is used to set a goal depth and the PD controller is applied to the depth. Depth is a very precise, robust and high-update-rate measurement, enabling effective altitude control even at very low altitude. Obstacle avoidance is provided by forward-looking beams of the DVL sonar system and, if required, is supplemented by a forward-looking multibeam sonar. Such systems may be less pertinent, although still useful in a manned vehicle.

Again, it is readily understood that the instant invention can be paired with numerous types of aquatic vehicles and vessels, whether autonomous man operated, or both. In fact, while Sentry is in principle an autonomous vehicle, it does incorporate two low bandwidth (128 b/30 s or 2 kb/30 s) acoustic modems. During initial testing, the modem was used to receive telemetry from both Sentry and SyPRID sampler and allowed for incremental steps toward more aggressive (lower level) flight characteristics within a single dive. The modem communications allowed for rapid operations development during a single dive and were used to confirm the functionality of the SyPRID sampler impellers.

### Test Run and Results

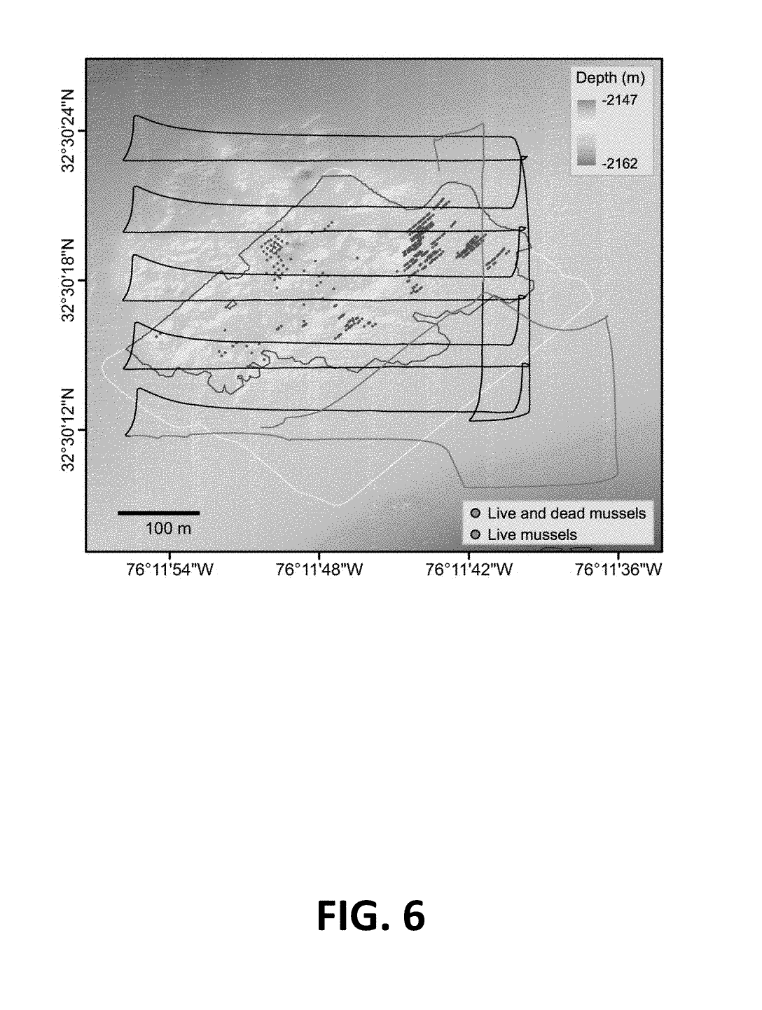

SyPRID was deployed for an experimental test run during R/V Atlantis AT29-04 (July 2015) to the Blake Ridge North seep area (32.505142 N, −76.196501 W) on Sentry Dive 322 (9-10, July 2015). The mission was terminated on schedule to allow for an on-time ALVIN dive launch. Plankton was sampled at ˜2150 m along ten 100 m long, East-West track lines and two North-South track lines spaced at 10 m intervals (1.2 km total, FIG. 6). Sentry began at an altitude of 60 m but, via the acoustic modem, the flight controls were gradually enabled to allow flight 5-mab. Sentry then flew at an altitude of 5 m (SyPRID intake altitude of 6 m) during a ˜6 hour interval. With a conservatively estimated flow rate of 500 m³h⁻¹ through each sampling chamber based on the design parameters, this would correspond to a total sample volume of 6,000 m³ (3,000 m³ per chamber) at 6 m altitude (or nearly 2.5× the volume of an Olympic swimming pool and roughly 5× to 6× the volume reported for a 1 m² MOCNESS sample across a 100 m deep stratum in an oblique tow).

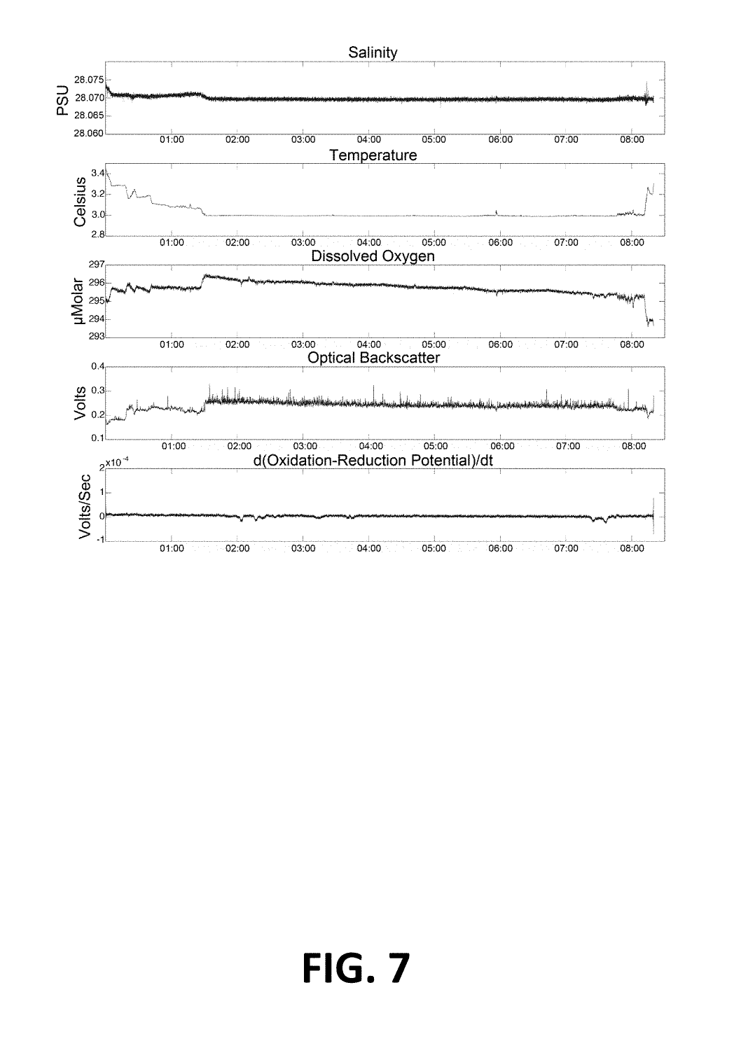

Through onboard sensors 14 SyPRID collected simultaneous temperature, salinity, optical backscatter, oxygen, and oxidation-reduction potential data during the mission (FIG. 7). Magnetometer data was also collected but was not biological relevant in this sampling scheme. Sensor data from on-board sensors 14 indicated that the temperature was uniformly ˜3° C., salinity 28.1 psu, and there was an average 296 μmolar O₂ (˜75% saturation) at the collection depth. The most striking characteristics of the collection stratum were the lower temperature (3° C. at 5 m altitude vs 3.5° C. at 80 m altitude) and elevated optical backscatter (turbidity) with higher noise relative to the 5-80 m depths (0.3 V at sample depth, ˜0.2 V between 5 and 80 m). Redox anomalies (dORP/dt<5.0*std dORP/dt) were evident in the SE quadrant of the survey path, consistent with an as yet undiscovered site of active seepage. Once on deck, starboard and port filters 4 and cod ends 8 were removed and washed to collect the sample onto the sample disks 9, and samples were rinsed into collecting bins and stored in a 4° C. cold room.

SyPRID samples were sorted under dissecting microscopes. The port sample contained 39 larvae of 16 morphotypes plus juvenile echinoderms that had undergone metamorphosis either in the collector or water column. Quality of the specimens, including both soft-bodied larvae with and without shells, was excellent. There was potential surface contamination and low flow in the starboard plankton sampler, which appears to have been caused by slipping of a shaft coupling on the inlet valve. After repair, both samplers worked on subsequent deployments of SyPRID.

### EXAMPLE 2

As previously discussed, the instant invention may be used as a system instrumental in the remediation of non-bio particles including microplastics and foreign particles in bodies of water. Each year millions of metric tons of plastic are used around the globe, and a substantial portion of plastic debris enters the ocean and fresh waters and is carried by water currents, spreading throughout the water column where the debris interacts with the present ecosystem. Classes of plastics found commonly in the aquatic environment include, but are not limited to, low-density polyethylene, high-density polyethylene, polytetrafluoroethylene, polyethylene terephthalate, polypropylene, polysterene, foamed polysterene, nylon, thermoplastic polyester, poly(vinyl chloride), and cellulose acetate. In addition to animal entanglement in plastic materials, plastics in the size range of 1 mm to 5 mm are being injected by aquatic animals which is then passed on in human consumption. Plastics have also been shown to serve as floating substrates for microbes, altering the natural ecosystem in the water. Therefore, it is crucial to determine the distribution of plastics, specifically microplastics, in the water and establish effective systems and methods for remediation efforts to remove the plastic debris.

It is an object of at least one embodiment of the instant invention to provide an apparatus capable of sampling, measuring, collecting, and otherwise removing plastic debris from a range of depths in the water column and near the seafloor. The majority of microplastics are less than 5 mm in diameter, and can be collected using the sampling apparatus by constructing the filter means (e.g., disk) to retain material less than 5 mm or other preferred size based on the membrane or mesh employed. In some embodiment, the apparatus is capable of removing plastic particles from the aquatic environment which are less than 20 mm, 10 mm to 5 mm, 5 mm to 1 mm, less than 1 mm, and less than 1 cm. The smallest size particle varies on the specific type of filter means used and depends on retaining the balance of pressure forces exerted on the sampled particles and the rate of water flow through the system. Although in some embodiments, the flow rate of the water may be increased as plastic particles are less likely to degrade.

As plastic particles drift through the water column, a portion of the particles settles in the bottom sediment. In certain embodiments capable of sampling near bottom, the present invention may employ techniques to deliberately resuspend sediment to collect settled plastic particles such as using the vehicles propulsion system to move sediment into the water column, making physical contact (or very close contact) with the bottom, or any means to shake up bottom-lying material to enter the apparatus.

For the purpose of understanding the Aqutic Sampler and Collection Apparatus, references are made in the text to exemplary embodiments of an Aquatic Sampler and Collection Apparatus, only some of which are described herein such as the SyPRID system. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

Reference throughout this specification to features, advantages, or similar language does not imply that all of the features and advantages that may be realized should be or are in any single embodiment. Rather, language referring to the features and advantages is understood to mean that a specific feature, advantage, or characteristic described in connection with an embodiment is included in at least one embodiment. Thus, discussion of the features and advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the act of collecting particles from aquatic environments may be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment.

Moreover, the terms “substantially” or “approximately” as used herein may be applied to modify any quantitative representation that could permissibly vary without resulting in a change to the basic function to which it is related.

What is claimed:

1. A sampling and collection apparatus for in situ sampling of particles in an aquatic environment, the apparatus comprising:
a. an outer collection tube further comprising at least one inlet adapted to allow fluids to enter the apparatus and at least one outlet;
b. an interior tube, at least a portion of which is capable of being housed within the outer collection tube;
c. a flow pump capable of drawing fluid into the apparatus;
d. a filter means disposed within the outer collection tube;
e. a fluid blocking means; and
f. an attachment means adapted to secure the system to an aquatic vehicle or platform;
wherein the inlet is diametrically larger than the interior tube.

2. The apparatus of claim 1, wherein the interior tube comprises a front opening, at least a portion of the filter means is in fluid communication with the interior of the interior tube, and the fluid blocking means is capable of controllably blocking at least some fluid from entering the interior tube.

3. The apparatus of claim 1, wherein the fluid blocking means is a valve selected from a group comprising a butterfly valve, a ball valve, a gate valve, a disc valve, a knife valve, a pinch valve, a plug valve, a spool valve, a sampling valve, and a globe valve.

4. The apparatus of claim 1, wherein the aquatic vehicle or platform to which the apparatus is attached is selected from a group comprising a Remotely Operated Vehicle, an Autonomous Underwater Vehicle, a Hybrid Remotely Operated Vehicle, a Human Occupied Vehicle, a glider, a submarine, a mini-submarine, an underwater observatory, or a mooring.

5. The apparatus of claim 1, wherein the apparatus is configured so as to be capable of sampling within 10 meters of the floor of the aquatic environment.

6. The apparatus of claim 1, wherein the filter means comprises one of a net, a screen, a membrane, a filter, a film, a webbing, and a combination thereof.

7. The apparatus of claim 1, wherein the filter means comprises a mesh structure located near the aft end of the interior tube.

8. The apparatus of claim 7, wherein the interior tube comprises a conical cod end on its aft portion which funnels particles flowing through the aft end of the interior tube into the mesh structure.

9. The apparatus of claim 1, wherein the flow pump is selected from a group comprising an impeller unit, a fluid pump, a propeller unit, a waterjet, a turbine, or a combination thereof.

10. The apparatus of claim 1, wherein the apparatus further comprises at least one sensor selected from a group comprising thermometers, magnetometers, hydrometers, radar, depth sensors, gravitometers, oximeters, light meters, GPS, seismographs, Geiger counters, and salinometers.

11. The apparatus of claim 10, wherein the interior tube comprises a front opening, at least a portion of the filter means is in fluid communication with the interior of the interior tube, the fluid blocking means is capable of controllably blocking at least some fluid from entering the interior tube, and the fluid blocking means is controlled based on a reading from at least sensor.

12. The apparatus of claim 1, wherein the apparatus is adapted to sample particles selected from plankton, plastics, microplastics, harmful algal blooms, larvae, microorganisms, and a combination thereof.

13. An apparatus for the collection of particles in an aquatic environment comprising:
a. an aquatic vehicle; and
b. at least one sampler unit wherein the sampler unit further comprises
i. an outer collection tube comprising an inlet and an outlet;
ii. an interior tube housed within the outer collection tube with a front opening and an aft cod end;
iii. a flow pump located in the aft section of the sampler unit; and
iv. a structure located aft to the cod end for collecting particles;
wherein the apparatus is configured such that particles of a sufficient size that enter the interior tube are incapable of exiting the interior tube through the sides and can only exit through the cod end when the flow pump is operating.

14. The apparatus of claim 13 further comprising a controllable valve that is capable of opening or closing a passage to the interior tube front opening.

15. The apparatus of claim 14 further comprising a controllable valve that is capable of opening or closing a passage to the interior tube front opening, and wherein the opening or closing of the valve is determined based on a parameter of interest as measured by at least one sensor.

16. The apparatus of claim 13, wherein the inlet of the outer collection tube is flared outwards from the outer collection tube in a frustum conical in shape.

17. The apparatus of claim 13, wherein at least one sensor is mounted onto the apparatus on either the aquatic vehicle or the sampler unit, and the at least one sensor is selected from the group comprising thermometers, magnetometers, hydrometers, radar, depth sensors, gravitometers, oximeters, light meters, GPS, seismographs, Geiger counters, and salinometers.

18. The apparatus of claim 13, wherein the flow pump pulls fluids and particles from the ambient environment into the system and at least a portion of the fluids and particles through the filter means.

19. The apparatus of claim 18, wherein the volume of fluid moved by the flow pump is controllable, and wherein the flow pump is capable of creating a constant pressure across at least a portion of the sampler unit interior.

20. The apparatus of claim 13, wherein a net is located within the interior tube that is capable of preventing particles above a designated size from escaping at least the sides of the interior tube.

21. The apparatus of claim 13, wherein the apparatus is configured to collect or sample within a depth from bottom selected from the group comprising 50 meters, 25 meters, 20 meters, 15 meters, 10 meters, 5 meters, and 1.5 meters.

22. The apparatus of claim 13, wherein the apparatus is adapted to sample particles selected from plankton, plastics, microplastics, harmful algal blooms, larvae, microorganisms, and a combination thereof.
